(19) United States
(12) Patent Application Publication
(10) Pub. No.: US 2005/0037115 A1
(43) Pub. Date: Feb. 17, 2005

(54) Carotenoid nanodispersions for use in water-based systems and a process for their preparation

(76) Inventors: Linda Fullmer, Ankeny, IA (US); Tatania Emmick, Milo, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/641,774

(22) Filed: Aug. 15, 2003

(51) Int. Cl. A23L 1/27

(52) U.S. Cl. 426/250

(57) ABSTRACT

A stable product containing an aqueous solution of one or more carotenoids for use in supplementing aqueous systems, such as foods, beverages, dietary supplements, and personal care products, with the carotenoid. An ester is dissolved in water and a source of the carotenoid is added to the solution. The concentrated product may be added to the aqueous systems or dried to form a powder that is readily dispersible in aqueous systems. The product may also include an antioxidant to preserve the activity of the carotenoid. Esters particularly suited for use include sucrose fatty acid esters. The product is produced without the use of organic solvents or elevated temperatures. The particles of carotenoids dispersed in the liquid form of the product will pass through a 0.2 micron (μm) sterile filter.

### BACKGROUND OF THE INVENTION

1. Field of the Invention

The invention relates generally to additives for water-based systems such as food, beverage, and personal care products and, more specifically, to nanodispersions of carotenoids for use in supplementing foods, beverages, dietary supplements, and personal care products with carotenoids, for use in coloring foods and beverages, and to a process for their preparation.

2. Background of the Art

Carotenoids are naturally-occurring yellow to red pigments of the terpenoid group that can be found in plants, algae, and bacteria. Carotenoids include hydrocarbons (carotenes) and their oxygenated, alcoholic derivatives (xanthophylls). They include actinioerythrol, astaxanthin, bixin, canthaxanthin, capsanthin, capsorubin, β-8′-apo-carotenal (apo-carotenal), β-12′-apo-carotenal, α-carotene, β-carotene, “carotene” (a mixture of α- and β-carotenes), γ-carotene, β-cryptoxanthin, lutein, lycopene, violerythrin, zeaxanthin, and esters of hydroxyl- or carboxyl-containing members thereof. Many of the carotenoids occur in nature as cis- and trans-isomeric forms, while synthetic compounds are frequently racemic mixtures. The carotenes are commonly extracted from plant materials. For example, lutein extracted from marigold petals is widely used as an ingredient in poultry feed where it adds color to the skin and fat of the poultry and to the eggs produced by the poultry. Many of the carotenes are also made synthetically; much of the commercially available β-carotene has been made through synthesis.

Carotenoids are used in the pharmaceutical industry and as ingredients in nutritional supplements, most commonly to date because of their pro-vitamin A activity. They have been extensively studied as antioxidants for protection against cancer and other human and animal diseases. Among the dietary carotenoids, the focus has been on β-carotene. More recently, research has begun to elicit the broad role that other carotenoids play in human and animal health. The xanthophylls in particular have been shown to possess strong antioxidant capabilities and may be useful in reducing the risk of disease. For example, the consumption of lutein and zeaxanthin has been identified as leading to a 57 percent reduction in age-related macular degeneration (Seddon et al., 1994. J. Amer. Med. Assoc. 272(18): 1413-1420). Lycopene has been identified as a nutrient that is active in reducing the risk of prostate cancer.

Carotenoids have also been of wide interest as a source of added color for food and drink products and many efforts have been made to attempt to use them as “natural” colorants for foods and beverages. However, their insolubility in water, their low solubility in fats and oils, high melting points, and their sensitivity to oxidation has limited their use, particularly in water-based products such as beverages and juices and products to which water is to be added.

Current processes for incorporating carotenoids into water-based beverages or foods involve the use of organic solvents, oils with emulsifiers, high heating, or high-shear mixing. Many of the current processes, particularly in beverages, produce a deposit of the carotenoids around the perimeter of the container in the region of the surface of the treated food or beverage, known as “ringing.” Optical clarity is a critical characteristic for many beverage compositions. Various fruit drinks, fruit juices and fortified water drinks have included terms such as “crystal clear” and “fresh” to distinguish their image and marketability. Traditionally, this clarity has been difficult to achieve when carotenoids are added to these aqueous compositions. The use of emulsifiers and oil for the incorporation of carotenoids will commonly result in cloudiness of the final aqueous composition.

In U.S. Pat. No. 3,998,753, a dispersible carotenoids product is made by forming a solution of carotenoids and a volatile organic solvent and emulsifying the solution with an aqueous solution containing sodium lauryl sulfate using high speed mixing with high shear. The volatile solvent is removed by heating the emulsion while maintaining the high speed mixing with high shear.

In U.S. Pat. No. 5,532,009, a powdered water soluble β-carotene composition is prepared by initially forming an aqueous solution of cyclodextrin. The solution is heated to between 45 and 95° C. Separately, β-carotene is dissolved in an organic solvent to form a supersaturated solution of β-carotene. The β-carotene solution is added to the hot cyclodextrin solution with rapid stirring. Upon drying, the powders are added to non-digestible fats, including polyol fatty acid polyesters and poly glycerol esters.

In U.S. Pat. No. 5,607,707, an antioxidant is dispersed in an emulsifier while heating to 40° C. The carotenoid is then added and the temperature is raised to between 80 and 200° C. while stirring. The mixture is then added to water (at least 95° C.) while stirring.

In U.S. Pat. No. 5,895,659, carotenoid suspensions are prepared by dissolving the carotenoid in a volatile, water-miscible organic solvent at preferably between 150 and 2000 C within less than 10 seconds and immediately thereafter mixing the solution with an aqueous medium at from 0 to 90° C. An emulsifier is present either in the organic solvent or the aqueous medium or both.

Applicant is an owner of U.S. patent application Ser. No. 09/999,863, filed Oct. 23, 2001, now U.S. Pat. No. ______, which is incorporated herein by this reference. This patent disclosure describes finely dispersed carotenoid suspensions for use in foods, beverages, and personal care products as well as a method for their preparation. These suspensions are prepared without the use of organic solvents, oils with emulsifiers, high heating, or high-shear mixing. The carotenoids are added to an aqueous solution of an emulsifier, preferably a sucrose fatty acid ester, together with an anti-foaming agent.

### SUMMARY OF THE INVENTION

This invention relates to the formation of a stable carotenoid-containing nanodispersion composition with a particle size less than 200 nm, optionally less than 20 nm, and will allow for the incorporation of carotenoids in a aqueous system at a level of 1.3 mg/ml or greater. Previously, the best known product for adding carotenoids to water-based systems allowed for the incorporation of carotenoids into aqueous systems without the use of organic solvents, oils with emulsifiers, high heating or high shear mixing. Additionally, the previous product prevented the undesireable characteristics of ringing and clouding in finished beverage products. However, the limit of the previous product was a maximum inclusion level of about 1.5 mg carotenoid in a 240 ml volume aqueous system. Higher inclusion levels typically resulted in some degree of settling or clouding. The present invention allows for inclusion levels of 1.3 mg carotenoid per 1 ml volume or greater. Additionally, the size of the carotenoid particles of the prior art product would not allow them to pass through a 0.2 μm (200 nm) sterile filter, a filter that is in common use in the food industry for filtering out microorganisms. The carotenoid particle size of the present invention will permit the carotenoid particles to pass through a 0.2 μm filter and thus permit much easier use and broader applications of use of products of the present invention.

The present invention allows for the solubilizing of the carotenoid by producing a food-grade composition containing the nanoparticulate dispersion of the carotenoid. The composition can then be incorporated into solution at very high payloads of the carotenoid. The production of a food-grade carotenoid nanodispersion or solution in water based systems has not been accomplished prior to this invention. The present invention allows for incorporation of the carotenoid at payloads 200 times the previous allowable levels. Additionally, this invention will also allow for the sterile incorporation of carotenoids post-processing using a 0.2 μm sterile filter.

The present invention involves the preparation of solution of sucrose fatty acid esters or polyglycerol esters in water. It is preferable that the ester has an HLB (hydrophobic-lipophilic balance) value of 15 or greater. This HLB value is important for achieving maximum nanopdispersion properties and the highest levels of carotenoid incorporation. Emulsifiers may be used singly or in combination; in particular, emulsifiers having diverse HLB numbers may be advantageously used in combination with each other. The amount of emulsifier in the composition is selected as an amount which will vary depending upon which form of carotenoid is used, its method of preparation, and how much is included. A food-grade antifoam may be added if foaming is undesirable. Antioxidants may also be incorporated. The crystalline carotenoid is then added until saturated (usually 1% or greater by weight). Examples of crystalline carotenoids that can be used in the practice of this invention include but are not limited to lutein, beta-carotene, beta-cryptoxanthin, lycopene, canthaxanthin, alpha-carotene and zeaxanthin. The above carotenoids may be incorporated individually or in combination. This procedure can be varied in the order in which the ingredients are added to the solution. The preparation may be gently heated to increase the amount of carotenoid incorporated into the nanodispersion. The preparation is then allowed to separate over time or centrifuged to aid separation. The mixture is then passed through a filter (0.2 μm) and the stable nanopdispersion is collected.

The liquid preparation can be added directly to an aqueous system such as a beverage, liquid dietary supplement, or personal care formulation. This invention does not require any heating or homogenization for its incorporation, thus being very conducive for incorporation into any type of composition. This invention prevents separation of the carotenoids from the aforementioned compositions. This invention imparts no ringing or settling and provides high optical clarity in the final system.

The liquid preparation can also be dried to provide a water-dispersible powder. The powder will also provide the same stable nanopdispersion offered by the liquid form. The water can be removed using lyophilization, spray-drying and other drying techniques.

The water and emulsifier mixture, under certain circumstances, may become too viscous for efficient processing. In these circumstances, a food-grade alcohol, such as ethanol, may be added to reduce the viscosity. It is preferred that no more than about 4 weight percent alcohol be used. In commercial processing of the product of the present invention, it is greatly preferred not to include the alcohol in the mixture since it adds a flammable substance to an otherwise nonflammable mixture and thus creates safety issues which add substantially to the costs associated with carrying out the process.

Any suitable commercially available anti-foam agent may be added to the mixture. Examples of suitable anti-foam agents include Silicone AF-100 FG (Thompson-Hayward Chemical Co.), ‘Trans’ Silicone Antifoam Emulsion (Trans-Chemco, Inc.), and 1920 Powdered Antifoam (Dow Corning Chemical). The amount of the anti-foam agent added is kept to the minimum required to prevent excessive foaming during processing of the product and, if desired by the consumer of the product, to prevent excessive foaming during processing of the food or beverage into which the product is being incorporated. Amounts of the anti-foam agent between 1 ppm and up to about 10 ppm in the final product are to be used.

It may be desired to incorporate an antioxidant into the mixture to assist in the prevention of oxidation of the carotenoid so as to preserve its color and activity. Antioxidants known for use in stabilizing carotenoids include tocopherols, extracts of rosemary, ascorbyl palmitate, citric acid, ascorbic acid, BHA, and BHT.

Carotenoids suitable for use in the product include actinioerythrol, astaxanthin, bixin, canthaxanthin, capsanthin, β-8′-apo-carotenal (apo-carotenal), β-12′-apo-carotenal, α-carotene, β-carotene, “carotene” (a mixture of α- and β-carotenes), γ-carotene, β-cryptoxanthin, lutein (a xanthophyll), lycopene, violerythrin, zeaxanthin, and esters of hydroxyl- or carboxyl-containing members thereof. Preferably, the carotenoids are in crystalline form. Examples of crystalline carotenoids which can be used in the practice of this invention include lutein, β-carotene, β-cryptoxanthin, α-carotene, lycopene, astaxanthin, canthaxanthin, and zeaxanthin. The carotenoids may be incorporated individually or in combination.

The concentrated product of the present invention is a nanodispersion of the carotenoid in the water and emulsifier mixture. Even upon optical microscopic examination, individual crystals are not observed. The dried product, if desired, may be incorporated into beverages to yield a beverage that is optically clear. The term “optically clear” is used to describe a product exhibiting a percentage transmittance value of between about 95% and about 100%, determined at a wavelength of 800 nm in a 1 cm path length cuvette. The optical clarity of the finished products obtainable with the present invention indicates that the carotenoids are present in a nanodispersion. This fine dispersion of carotenoids in aqueous preparations may help to promote the efficient uptake of such materials by body tissues when the composition is presented to the body. Moreover, the presence of the emulsifier is also believed to assist in the efficient transfer of these substances across cellular membranes. While the present invention is particularly suited to the production of optically clear products, the present invention can also be used to prepare opaque, cloudy products, specifically juices, soups, sauces, and syrups. The invention is also suitable for use as an additive to fortified foods, such as ready-to-eat cereals, sports and nutrition bars, bread, and the like. The invention provides for a more efficient uptake of nutrients and therefore is useful as a new delivery system for such nutrients.

The dispersions of the carotenoids created by the present invention, whether in the concentrated product or in the finished composition, are substantially stable. No ringing of the carotenoids is observed after storage in excess of one-year at ambient temperatures. Repeated chilling and heating of the product did not reveal any changes in its physical characteristics. The stability of the carotenoid products also makes them attractive as colorants and additions to personal care products which have an aqueous phase, such as lotions, emollients, sun screens, and the like.

It is an object of the present invention to provide a nanodispersion wherein the particle size is between about 2 nm and about 200 nm, appropriate for the requirements for the application of carotenoid suspensions which can be added to foods and beverages, and a process for their preparation.

It is another object of the present invention to provide a process for preparing a nanodispersion of carotenoids which avoids the use of organic solvents, elevated temperatures, high speed mixing, or high-shear mixing.

It is a further object of the present invention to provide a nanodispersion of carotenoids which are physiologically acceptable, and a process for their preparation.

These and other objects of the invention will be made apparent to those skilled in the art upon a review and understanding of this specification and the appended claims.

### DETAILED DESCRIPTION OF A PREFERRED EMBODIMENT

The process according to the invention is preferably used to prepare finely dispersed carotenoid solutions for use to supplement foods and beverages with carotenoids, for use in coloring personal care products, foods and beverages, dietary supplements, and to a process for their preparation.

Examples of carotenoids which can be used according to the invention are the known, available, natural or synthetic representatives of this class of compounds, for example actinioerythrol, astaxanthin, bixin, canthaxanthin, capsanthin, capsorubin, β-8′-apo-carotenal (apo-carotenal), β-12′-apo-carotenal, α-carotene, β-carotene, “carotene” (a mixture of α- and β-carotenes), γ-carotene, β-cryptoxanthin, lutein, lycopene, violerythrin, zeaxanthin, and esters of hydroxyl- or carboxyl-containing members thereof. The preferred carotenoids are canthaxanthin, zeaxanthin, astaxanthin, lutein, β-carotene, and, lycopene.

Emulsifiers that can used in the present invention include all cationic, anionic, and nonionic emulsifiers that are also acceptable for ingestion or application in or to humans and animals on administration in the usual amounts and do not result in harm. Emulsifiers which can be used according to the invention include lecithin and lysolecithin, sucrose fatty acid esters, and poly glycol esters. In a preferred embodiment of the invention, sucrose fatty acid esters (SFAE) are used. Sucrose fatty acid esters are the mono-, di-, and tri-esters of sucrose with fatty acids and are derived from sucrose and edible tallow, hydrogenated edible tallow, or edible vegetable oils. The total content of mono-, di-, and tri-esters is greater than 70%. Sucrose esters are food-grade, odorless, nontoxic, and impart minimal flavor. They are also a non-irritant to the eyes and skin and so are suitable for pharmaceutical and cosmetic applications. Examples of SFAE particularly suited for use are sucrose stearate, sucrose palmitate, sucrose myristate, and sucrose laurate, for example, those sold under the product names S-1570, P-1570, LWA-1570, M-1695 and L-1695 by Mitsubishi-Kagaku Foods Corporation. Also preferred are poly glycol esters (PGE). Examples particularly suited for use are SWA-10D, L-7D, and L-10D available from Mitsubishi-Kagaku Foods Corporation.

The amounts of emulsifier(s) used are selected within a range which results in a finely dispersed, stable carotenoid suspension. In the liquid form of the concentrated product, the emulsifier comprises between about 1 to 40% by weight, and preferably between about 20% and about 30%; the carotenoid comprises between about 0.1 and about 20% by weight, and preferably between 5 and 10%; with water comprising the balance. Higher amounts of the emulsifier may be required if the carotenoid is supplied in a form containing an oil, whereas lower amounts generally will be sufficient if the carotenoid is supplied in the form of crystals.

An antioxidant can be added to the water and emulsifier mixture, to the concentrated product, and to the carotenoid prior to its addition to the water and emulsifier mixture. The antioxidant is used to increase the stability of the active ingredient to oxidative breakdown. The antioxidant if used is preferably dissolved together with the carotenoids in the water and emulsifier mixture. Examples of antioxidants which can be used include tocopherols, extracts of rosemary, ascorbyl palmitate, citric acid, ascorbic acid, BHA, and BHT. Other suitable antioxidants can also be used. The amount of antioxidant to be used depends on the particular antioxidant selected and the environment in which the carotenoid composition is to be used. The range of antioxidant is from about 0.01 to about 0.1 percent by weight, based on the weight of the carotenoid used in the composition.

The concentrated carotenoid products of this invention include from about 0.001 to about 0.5 percent by weight carotenoid, based on the weight of the concentrated product in liquid form, and between about 0.01 to about 2 percent by weight carotenoid, based on the weight of the concentrated product in dry form.

Use of an anti-foaming agent prevents undesirable foaming of the composition during processing of the concentrated product and during the manufacturing of food or beverage items to which the concentrated product has been added. The amount of anti-foam agent to be used depends on the particular agent selected and the composition and processing conditions of the food or beverage processor which will be using the concentrated product. The range of anti-foam agent is from about 1 to about 10 ppm, based on the weight of the concentrated product.

Visual or optical clarity is an important characteristic for many beverage compositions. Various fruit drinks, fruit juices and fortified water drinks have included terms such as “crystal clear” and “fresh” to distinguish their image and marketability. Traditionally, this clarity has been difficult to achieve when carotenoids are added to these aqueous compositions. The use of emulsifiers and oil for the incorporation of carotenoids will commonly result in cloudiness of the final aqueous composition. The present invention utilizes emulsifiers, preferably sucrose fatty acid esters (SFAE), to disperse carotenoids in beverages and other water-based systems, while maintaining their visual clarity. For the purposes of this disclosure, visual or optical clarity will be defined by the percent transmittance value determined at the wavelength of 800 nm in a 1 cm path length cuvette.

The processes to incorporate carotenoids into beverages that are in use today, utilize high shear mixing, organic solvents, high heating or oil and emulsifiers. Often times, the result of the carotenoid incorporation involves ringing of the carotenoid in the finished product. This characteristic is visually undesirable and requires considerable shaking of the beverage to redistribute the carotenoid. Many times the ring is adhered to the glass and becomes difficult, if not impossible to redistribute. The present invention utilizes emulsifiers, preferably sucrose fatty acid esters (SFAE), to disperse carotenoids in beverages and other water-based systems, while maintaining their stability against ringing.

There are several factors that may affect the stability against ringing in aqueous compositions. These include the level of SFAE that is required to keep the carotenoid in the suspension; the hydrophilic/lipophilic balance (HLB) of the SFAE, which may affect the interaction of the carotenoids with the aqueous composition; and the inclusion level of the SFAE/carotenoid suspension, which may determine the stability against ringing. The inherent compositional difference of fruit drinks and fortified water may suggest that they will have differences in stability against ringing. These factors have been examined to determine whether there are preferred levels of SFAE and carotenoids that contribute to the stability against ringing.

Manufacturing Process

The carotenoid suspensions are prepared according to the invention by dissolving the emulsifier in a quantity of water at ambient temperature, and mixing the solution until the emulsifier has been dissolved in the water. If used, the alcohol and/or the antioxidant are/is added to the water and emulsifier solution. An anti-foam agent may also be added. The particular order of addition of the alcohol, antioxidant, and anti-foam agent is not critical. The carotenoid is then mixed into the emulsifier solution until evenly dispersed. The resulting concentrated product is used by food and beverage processors to add either color or supplementation of carotenoids, or both, to their products by adding the concentrated product at an appropriate step in their manufacturing process. The concentrated product is a viscous liquid that may be dispensed by liquid metering devices commonly used by food and beverage processors. Alternatively, the concentrated product may be dried to form a dispersible powder. Preferred methods of drying include lyophilization, spray drying, and, most preferably, horizontal thin-film evaporation. In the experiments described herein, the compositions were dried until the total moisture content was less than 1%.

### EXAMPLE 1

Preparation of Saturated Ester Solutions. For each ester, a 250 ml Erlenmeyer flask was filled with 150 ml of water. Several grams of ester were added to the appropriate flask. The flasks were stoppered and shaken on an orbital shaker at 300 rpm. Additional ester was added until undissolved ester remained after 1 hour of shaking. The samples were then transferred to 50 ml polypropylene conical centrifuge tubes and centrifuges at 10,000 rpm for 10 minutes. The supernatant was divided into 30 g samples and stored in 50 ml centrifuge tubes. Samples were analyzed using an Ohaus MB45 Moisture Balance to determine percent dissolved solids. A drying temperature of 100° C. was used with a fast ramping profile. Results were displayed when the mass lost is less than 1 mg in 90 seconds.

Preparation of Soluble Lutein Solutions. Approximately 0.5 g of crystalline lutein (˜0.375 g lutein) was added to a 30-gram sample of saturated ester solution. Samples were inverted to mix and homogenized with a biohomogenizer (Biospec Products, Inc) for 2 minutes. These samples were then divided into two 15 ml polypropylene conical centrifuge tubes. One 15 ml tube was placed in a 75° C. shaking water bath for 10 minutes. The samples were then allowed to stand in the dark for 24 hours to determine if the insoluble lutein would separate out. After 24 hours, samples were centrifuged at 4000 rpm for 30 minutes to aid in layer separation. The insoluble lutein was at the top of the solution. An attempt was made to remove a majority of this lutein and the remaining liquid was transferred to a clean 15 ml centrifuge tube. The solutions were filtered through a 0.2 μm syringe filter. The polyglycerol laurate and sucrose monolaurate samples were filtered through a 0.45 μm syringe filter because of high viscosity. The sucrose palmitate sample was vacuum filtered through a glass fiber filter with a pore size of less than 1.5 μm.

Lutein/Zeaxanthin Analysis. For all samples other than those made with polyglycerol laurate and polyglycerol oleate, the sample was massed into a 15 ml polypropylene conical centrifuge tube and diluted with 3 ml of water. The sucrose monolaurate and sucrose monomyristate samples were extracted with 10 ml of ethyl acetate, and the other esters were extracted with 5 ml of ethyl acetate. The extract was then analyzed via HPLC using a mobile phase of 75% hexanes, 25% methylene chloride, 0.4% methanol, and 0.1% diisopropylethylamine (v/v/v/v) in a 250 mm×4.6 mm nitrile bonded Supersob column (5 nm particles) (Waters Corporation) and a nitrile guard column cartridge (Regis Technologies) and compared against standard curves for lutein or zeaxanthin, as appropriate. An aliquot of the extract was also diluted in ethanol and the absorbance was read at 446 nm. For the polyglycerol laurate and polyglycerol oleate samples, the method was scaled up into a 50 ml centrifuge tube. The sample was diluted with 10 ml of 1M KOH and extracted with 10 ml of ethyl acetate. Sodium chloride was added to aid in layer separation. The centrifugation speed was increased to 7500 rpm, and the time was increased to 10 minutes.

Table 1 provides the materials that were used in preparing the compositions.

TABLE 1
Materials

| Material | Supplier | Lot Number |
|---|---|---|
| Sucrose Monolaurate | Mitsubishi Chemical | 14078101 and 1811911A |
| Sucrose Monomyristate | Mitsubishi Chemical | 0Y22A101 |
| Sucrose Palmitate | Applied Power | SP073001 |
| | Concepts | |
| Sucrose Monostearate | Daiichi Chemical | 848Y24 |
| Sucrose Acetate | Eastman | TD-1030507 |
| Isobutyrate | | |
| Polyglycerol Laurate | LIPO Chemical Inc | P-734A2 |
| Polyglycerol Cocoate | LIPO Chemical Inc | P-735A2 |
| Polyglycerol Oleate | LIPO Chemical Inc | P733A2 |
| FloraGLO Crystalline | Kemin Foods, L.C. | 083080-02 |
| Lutein | | |
| Ethyl Acetate | Fisher Scientific | 011771 |
| Sodium Chloride | Fisher Scientific | 016089 |
| Hexanes | Fisher Scientific | 011854 |
| Methylene Chloride | Fisher Scientific | 011598 |
| Methanol | Fisher Scientific | 001927 |
| Diisopropylethylamine | Aldrich | 11025L0 |

| | | | Ingre- |
|---|---|---|---|
| Product | Manufacturer | Chemical Name | dients (%) |
| L-1695 | Mitsubishi | 80% Sucrose | |
| | | monolaurate | |
| M-1695 | Mitsubishi | 80% Sucrose | |
| | | monomyristate | |
| FloraGLO ® | Kemin | Lutein | |
| Brand | Foods, L.C. | Zeaxanthin | |
| Crystalline | | | |
| Lutein | | | |
| Model | Kemin | | Water 72.71 |
| Beverage | Foods, L.C. | | HFCS 17.00 |
| System | | | Juice 10.00 |
| | | | Citric Acid |
| | | | 0.250 |
| | | | Ascorbic Acid |
| | | | 0.040 |
| Water | | | |
| Lycopene | Sigma | Lycopene | |
| β-Carotene | Sigma | β-Carotene | |
| Lutein Esters | Bioquimex | Lutein Esters | |
| | Reka | | |
| Zeaxanthin | Hoffman | Zeaxanthin | |
| | LaRoche | | |

Sucrose monolaurate was found to be the most soluble ester at 43.16%. This was followed by the polyglycerol cocoate and polyglycerol laurate at 38.93 and 25.78%, respectively. The next highest solubility of 7-8% was found with sucrose monomyristate and polyglycerol oleate. All other esters had poor solubility of less that 2%.

TABLE 2
Percent Dissolved Solids of Sucrose Ester
and Polyglycerol Ester Solutions

| Ester Sample | Average % Solids |
|---|---|
| Sucrose Monolaurate | 43.16 |
| Sucrose Monomyristate | 8.10 |
| Sucrose Palmitate | 0.65 |
| Sucrose Monostearate | 1.82 |
| Sucrose Acetate Isobutyrate | 0.61 |
| Polyglycerol Laurate | 25.78 |
| Polyglycerol Cocoate | 38.93 |
| Polyglycerol Oleate | 7.33 |

Filtered lutein/ester solutions were visually observed for clarity. All solutions were considered transparent except for the sucrose monopalmitate and polyglycerol oleate solutions. The sucrose acetate isobutyrate solution was both transparent and colorless giving initial indications that no lutein was soluble in the ester solution.

TABLE 3
Visual Clarity and Color of Lutein/Ester Solutions

| Ester | Treatment | Color | Visual Clarity |
|---|---|---|---|
| Sucrose Monolaurate | Heated | Red | Yes |
| Sucrose Monolaurate | Not Heated | Red-Orange | Yes |
| Sucrose Monomyristate | Heated | Orange-Red | Yes |
| Sucrose Monomyristate | Not Heated | Orange | Yes |
| Sucrose Palmitate | Heated | Light Orange | No |
| Sucrose Palmitate | Not Heated | Light Yellow | No |
| Sucrose Monostearate | Heated | Orange | Yes |
| Sucrose Monostearate | Not Heated | Yellow | Yes |
| Sucrose Acetate Isobutyrate | Heated | Colorless | Yes |
| Sucrose Acetate Isobutyrate | Not Heated | Colorless | Yes |
| Polyglycerol Laurate | Heated | Orange-Red | Yes |
| Polyglycerol Laurate | Not Heated | Orange-Red | Yes |
| Polyglycerol Cocoate | Heated | Orange | Yes |
| Polyglycerol Cocoate | Not Heated | Orange | Yes |
| Polyglycerol Oleate | Heated | Yellow | No |
| Polyglycerol Oleate | Not Heated | Yellow | No |

TABLE 4
UV-Visible Analysis of Lutein/Ester Solutions

| | | | Sample | | |
|---|---|---|---|---|---|
| | | Repli- | Mass | Dilution | Absorbance |
| Ester | Treatment | cate | (g) | Factor | @ 446 nm |
| Sucrose | Heated | 1 | 0.1448 | 250 | 0.19261 |
| Monolaurate | | 2 | 0.1776 | 250 | 0.23187 |
| | Not Heated | 1 | 0.1567 | 250 | 0.079979 |
| | | 2 | 0.2129 | 250 | 0.11100 |
| Sucrose | Heated | 1 | 0.1991 | 125 | 0.12532 |
| Monomyristate | | 2 | 0.2258 | 125 | 0.13826 |
| | Not Heated | 1 | 0.2525 | 83.3 | 0.082802 |
| | | 2 | 0.3011 | 83.3 | 0.097193 |
| Sucrose | Heated | 1 | 0.5204 | 5 | 0.23667 |
| Palmitate | | 2 | 0.5489 | 5 | 0.23936 |
| | Not Heated | 1 | 0.7819 | 5 | 0.19534 |
| | | 2 | 0.8073 | 5 | 0.19391 |
| Sucrose | Heated | 1 | 0.3257 | 41.65 | 0.096412 |
| Monostearate | | 2 | 0.3024 | 41.65 | 0.10884 |
| | Not Heated | 1 | 0.3772 | 5 | 0.27092 |
| | | 2 | 0.3810 | 5 | 0.28133 |
| Sucrose | Heated | 1 | 1.0409 | 5 | −0.01798 |
| Acetate | | 2 | 1.0210 | 5 | −0.0066648 |
| Isobutyrate | Not Heated | 1 | 1.0474 | 5 | −0.015073 |
| | | 2 | 1.0614 | 5 | 0.0087032 |
| Polyglycerol | Heated | 1 | 0.5096 | 125 | 0.25266 |
| Laurate | | 2 | 0.5228 | 125 | 0.26053 |
| | Not Heated | 1 | 0.6586 | 125 | 0.25427 |
| | | 2 | 0.6471 | 125 | 0.24481 |
| Polyglycerol | Heated | 1 | 0.3774 | 41.65 | 0.15313 |
| Cocoate | | 2 | 0.3641 | 41.65 | 0.14826 |
| | Not Heated | 1 | 0.4355 | 41.65 | 0.20348 |
| | | 2 | 0.3980 | 41.65 | 0.18003 |
| Polyglycerol | Heated | 1 | 0.8460 | 62.5 | 0.090377 |
| Oleate | | 2 | 0.8467 | 62.5 | 0.085584 |
| | Not Heated | 1 | 0.8823 | 50 | 0.085639 |
| | | 2 | 0.8713 | 50 | 0.076451 |

TABLE 5
Carotenoid Profile of Lutein/Ester Solutions

| | | % | % | % | % |
|---|---|---|---|---|---|
| | Treat- | Caro- | trans- | cis-lutein | zeaxan- |
| Ester | ment | tenoids | lutein | isomers | thin |
| Sucrose | Heated | 1.292e−1 | 1.16e−1 | 2.8e−3 | 7.9e−3 |
| Monolaurate | | | | | |
| Sucrose | Not | 5.06e−2 | 4.60e−2 | ND | 3.6e−3 |
| Monolaurate | Heated | | | | |
| Sucrose | Heated | 3.04e−2 | 2.78e−2 | 3e−4 | 1.7e−3 |
| Monomyristate | | | | | |
| Sucrose | Not | 1.06e−2 | 9.5e−3 | 1e−4 | 8e−4 |
| Monomyristate | Heated | | | | |
| Sucrose | Heated | 8.73e−4 | 7.85e−4 | 2.87e−5 | 4.99e−5 |
| Palmitate | | | | | |
| Sucrose | Not | 4.80e−4 | 4.48e−4 | ND | 2.80e−5 |
| Palmitate | Heated | | | | |
| Sucrose | Heated | 5.36e−3 | 4.61e−3 | 2.25e−4 | 3.15e−4 |
| Monostearate | | | | | |
| Sucrose | Not | 1.43e−3 | 1.08e−3 | 1.66e−4 | 7.48e−5 |
| Monostearate | Heated | | | | |
| Sucrose | Heated | ND | ND | ND | ND |
| Acetate | | | | | |
| Isobutyrate | | | | | |
| Sucrose | Not | ND | ND | ND | ND |
| Acetate | Heated | | | | |
| Isobutyrate | | | | | |
| Polyglycerol | Heated | 2.44e−2 | 2.09e−2 | 9e−4 | 1.2e−3 |
| Laurate | | | | | |
| Polyglycerol | Not | 1.87e−2 | 1.633−2 | 4e−4 | 1.4e−3 |
| Laurate | Heated | | | | |
| Polyglycerol | Heated | 6.6e−3 | 5.5e−3 | 5e−4 | 3e−4 |
| Cocoate | | | | | |
| Polyglycerol | Not | 7.5e−3 | 6.5e−3 | 6e−4 | 5e4 |
| Cocoate | Heated | | | | |
| Polyglycerol | Heated | 2.55e−3 | 2.09e−3 | 1.80e−4 | 1.49e−4 |
| Oleate | | | | | |
| Polyglycerol | Not | 1.81e−3 | 1.42e−3 | 1.83e−4 | 1.11e−4 |
| Oleate | Heated | | | | |

The carotenoid profile of the lutein/ester solutions was evaluated (Table 5). The largest percent lutein values were found in the sucrose monolaurate and sucrose monomyristate solutions. Carotenoid solubility increased when samples were heated. The ratios of lutein to ester were compared before and after heating (Table 6). Sucrose monostearate, sucrose monomyristate and sucrose monolaurate showed the greatest increase in lutein solubility upon heating. After removing water, these solutions would theoretically yield dry powders containing 0.253, 0.343, and 0.269% lutein, respectively.

TABLE 5
Lutein to Ester Ratio

| | Ratio | Ratio | Factor of |
|---|---|---|---|
| Ester | With Heat | Without Heat | Increase w/Heat |
| Sucrose Monolaurate | 2.69e−3 | 1.07e−3 | 2.52 |
| Sucrose | 3.43e−3 | 1.17e−3 | 2.93 |
| Monomyristate | | | |
| Sucrose Palmitate | 1.21e−3 | 6.89e−4 | 1.75 |
| Sucrose | 2.53e−3 | 5.93e−4 | 4.27 |
| Monostearate | | | |
| Sucrose Acetate | 0 | 0 | 0 |
| Isobutyrate | | | |
| Polyglycerol Laurate | 7.95e−4 | 6.20e−4 | 1.28 |
| Polyglycerol Cocoate | 1.41e−4 | 1.67e−4 | 0.85 |
| Polyglycerol Oleate | 2.86e−4 | 1.94e−4 | 1.47 |

Lutein solubility in aqueous solutions of various sucrose esters and polyglycerol esters was investigated. The effect of heating on the lutein solubility was also investigated. The esters investigated include sucrose monolaurate, sucrose monomyristate, sucrose palmitate, sucrose monostearate, sucrose acetate isobutyrate, polyglycerol laurate, polyglycerol cocoate and polyglycerol oleate. The best results were obtained with sucrose monolaurate, sucrose monomyristate and sucrose monostearate. Approximately 0.12% lutein was soluble in a 43% solution of sucrose monolaurate. Upon drying, this would theoretically yield a 0.27% lutein product. In an 8% solution of sucrose monomyristate, 0.027% lutein was found to be soluble. When dried this would yield a 0.34% lutein product. In a 1.82% solution of sucrose monostearate, 0.00461% lutein was found to soluble. This would yield a dry product with 0.25% lutein. The theoretical maximum lutein inclusion level in a 240 ml beverage that could be obtained with these dry products would be 288 mg lutein with sucrose monolaurate, 65 mg lutein with sucrose monomyristate, and 11 mg with sucrose monostearate.

### EXAMPLE 2

The inclusion levels of various carotenoids were determined using two sucrose fatty acid esters. The crystalline carotenoids that were investigated included canthaxanthin (ChromaDex, lot 01-03115-215), zeaxanthin (Roche, lot UE00010005), astaxanthin (Sigma, lot 87H0198), β-carotene (Sigma, lot 110K2519), lycopene (Sigma, lot 092K7015) and lutein dry cake (Kemin Foods, lot 084503-01). Approximately a 1% by weight solution of each carotenoid was prepared using an aqueous 20% monolaurate and an aqueous 7% sucrose monomyristate solution, respectively. Two samples of canthaxanthin were prepared due to the low purity of the sample (˜10% canthaxanthin), the second sample had ten times as much sample massed for purity correction. Each carotenoid was massed using a Fisher Scientific, model accu-124D, analytical balance into 15 mL conical centrifuge tubes. After the preparation of the carotenoid/sucrose ester solutions, each was vortexed for approximately 5 minutes using the Fisher Scientific Vortex Genie 2 to allow for complete incorporation. All of the samples were prepared at the same time except the lycopene and the lutein dry cake. These were prepared two days later due to availability.

The 1% carotenoid solutions were transferred into 2 mL centrifuge tubes. The samples were then centrifuged using an Eppendorf 5810 centrifuge at 4000 rpm for thirty minutes, to aid in layer separation. The mixture was then passed through a 0.2 μm filter and collected into a clean 2 mL centrifuge tube.

The soluble carotenoid was extracted from each sample using the following method and was performed in duplicate. Approximately 100 mg of each sample was massed into 15 mL conical centrifuge tubes to which 3 mL of water was added. Each tube was then inverted for mixing. To each tube, 5 mL of ethyl acetate was delivered using a 5 mL class A pipette and again inverted to mix. Approximately 1 g of sodium chloride was added and the tubes were then balanced within +/−0.1 g using water. The samples were centrifuged at 2000 rpm for five minutes to aid layer separation.

The extracted layer was then diluted accordingly using ethanol or hexanes, after which the samples were analyzed using a Hewlett Packard UV-Vis Spectrophotometer 8453.

HPLC samples were prepared for the lutein cake by transferring 250 μl of the extracted upper layer into amber HPLC vials. The transfer of the sample was done using a Pipetman with a positive displacement tip. The ethyl acetate was dried using a gentle nitrogen stream and upon completion, 1 mL of mobile phase (75% hexanes: 25% methylene choride: 0.4% methanol: 0.1% diisopropylethylamine v/v/v/v) was added. The prepared samples were then run on the Agilent 1100 series HPLC using the lutein/zeaxanthin analysis method described previously.

Calculations for Percent Carotenoids, Percent All Trans-Lutein, and Percent All Trans-Zeaxanthin:

$$\% carotenoid = \frac{( Abs @ λ max ) ( dilution factor )}{( Extraction Coefficient ) ( mass caroteniod )}$$

$$\% all trans \text{-} lutein = \frac{( HPLC Area \% for all trans \text{-} lutein )}{100} \times \% carotenoid$$

$$\% all trans \text{-} zeaxanthin = \frac{( HPLC Area \% for all trans \text{-} zeaxanthin )}{100} \times \% carotenoid$$

Results were obtained after analysis by UV-Vis and HPLC. The percent soluble carotenoid values can be seen in Table 7.

Initially all canthaxanthin samples were analyzed through the UV-Vis spectrophotometer using either hexanes or ethanol as the solvent. The canthaxanthin purity corrected samples soluble carotenoid values were reported using hexanes as the solvent. The high absorbance readings are possibly due the low solubility in hexanes and the low purity of the original sample.

The β-carotene solubility in sucrose monolaurate was the highest on average with 0.141%. The highest soluble carotenoid in sucrose monomyristate was canthaxanthin that on average was 0.059%

TABLE 7
Results of carotenoid solubilities in sucrose esters

| | | | | | | |
|---|---|---|---|---|---|---|
| | | | | Abs @ | Extinction | |
| Sucrose Ester | Sample | Mass (g) | Dilution | 460 nm | Coefficient | % Carotenoids |

Canthaxanthin

| | | | | | | |
|---|---|---|---|---|---|---|
| Monolaurate | 1 | 0.10226 | 125 | 0.07372 | 2200 | 0.040960653 |
| Monolaurate | 2 | 0.09946 | 125 | 0.07197 | 2200 | 0.041114061 |
| | | | | | Average | 0.041037357 |
| | | | | | Std. Dev. | 0.000108476 |
| Monomyristate | 1 | 0.10631 | 125 | 0.10835 | 2200 | 0.057908475 |
| Monomyristate | 2 | 0.10184 | 125 | 0.10988 | 2200 | 0.061303828 |
| | | | | | Average | 0.059606151 |
| | | | | | Std. Dev. | 0.002400877 |

Canthaxanthin Purity Correction

| | | | | | | |
|---|---|---|---|---|---|---|
| Monolaurate | 1 | 0.10750 | 125 | 0.78943 | 2200 | 0.417246300 |
| Monolaurate | 2 | 0.05041 | 125 | 0.67248 | 2200 | 0.757966493 |
| | | | | | Average | 0.587606397 |
| | | | | | Std. Dev. | 0.240925559 |
| Monomyristate | 1 | 0.07753 | 125 | 0.91702 | 2200 | 0.672041908 |
| Monomyristate | 2 | | | | | |
| | | | | | Average | |
| | | | | | Std. Dev. | |

Zeaxanthin

| | | | | | | |
|---|---|---|---|---|---|---|
| Monolaurate | 1 | 0.10237 | 125 | 0.15987 | 2540 | 0.076854724 |
| Monolaurate | 2 | 0.10596 | 125 | 0.16224 | 2540 | 0.075351566 |
| | | | | | Average | 0.076103145 |
| | | | | | Std. Dev. | 0.001062893 |
| Monomyristate | 1 | 0.10980 | 5 | 0.25248 | 2540 | 0.004526483 |
| Monomyristate | 2 | 0.09927 | 5 | 0.26274 | 2540 | 0.005210081 |
| | | | | | Average | 0.004868282 |
| | | | | | Std. Dev. | 0.000483376 |

Astaxanthin

| | | | | | | |
|---|---|---|---|---|---|---|
| Monolaurate | 1 | 0.10706 | 2.5 | 0.30548 | 2100 | 0.003396849 |
| Monolaurate | 2 | 0.10566 | 2.5 | 1.54520 | 2100 | 0.017409841 |
| | | | | | Average | 0.010403345 |
| | | | | | Std. Dev. | 0.009908682 |
| Monomyristate | 1 | 0.10850 | 2.5 | 0.021387 | 2100 | 0.000234661 |
| Monomyristate | 2 | 0.10880 | 2.5 | 0.027479 | 2100 | 0.000300672 |
| | | | | | Average | 0.000267666 |
| | | | | | Std. Dev. | 4.66767E−05 |

β-Carotene

| | | | | | | |
|---|---|---|---|---|---|---|
| Monolaurate | 1 | 0.10455 | 125 | 0.31058 | 2620 | 0.141728820 |
| Monolaurate | 2 | 0.10538 | 125 | 0.29560 | 2620 | 0.133830456 |
| | | | | | Average | 0.137779638 |
| | | | | | Std. Dev. | 0.005584987 |
| Monomyristate | 1 | 0.10824 | 125 | 0.013429 | 2620 | 0.005919222 |
| Monomyristate | 2 | 0.10332 | 125 | 0.007252 | 2620 | 0.003348838 |
| | | | | | Average | 0.004634030 |
| | | | | | Std. Dev. | 0.001817536 |

Lycopene

| | | | | | | |
|---|---|---|---|---|---|---|
| Monolaurate | 1 | 0.10090 | 2.5 | 0.17394 | 3450 | 0.001249192 |
| Monolaurate | 2 | 0.10281 | 2.5 | 0.17934 | 3450 | 0.001264046 |
| | | | | | Average | 0.001256619 |
| | | | | | Std. Dev. | 1.05030E−05 |
| Monomyristate | 1 | 0.10853 | 2.5 | 0.021128 | 3450 | 0.000141068 |
| Monomyristate | 2 | 0.10080 | 2.5 | 0.026733 | 3450 | 0.000192180 |
| | | | | | Average | 0.000166624 |
| | | | | | Std. Dev. | 3.61414E−05 |

Lutein Cake

| | | | | | HPLC Area | HPLC Area |
|---|---|---|---|---|---|---|
| | | Mass | | Abs @ | % for all | % for all |
| Sucrose Ester | Sample | (g) | Dilution | 460 nm | trans-lutein | trans-zeaxanthin |
| Monolaurate | 1 | 0.10437 | 25 | 0.13201 | 76.1904 | 6.6055 |
| Monolaurate | 2 | 0.10906 | 25 | 0.13572 | 74.5010 | 6.3902 |
| Monomyristate | 1 | 0.09990 | 25 | 0.11605 | 80.2375 | 6.1918 |
| Monomyristate | 2 | 0.10615 | 25 | 0.11947 | 80.2978 | 6.3627 |

Lutein Cake

| | | Extinction | % | % all | % all |
|---|---|---|---|---|---|
| Sucrose Ester | Sample | Coefficient | Carotenoids | trans-Lutein | trans-zeaxanthin |
| Monolaurate | 1 | 2550 | 0.012400265 | 0.00944781 | 0.00081910 |
| Monolaurate | 2 | 2550 | 0.012200516 | 0.00908951 | 0.00077964 |
| | | Average | 0.012300390 | 0.00926866 | 0.00079937 |
| | | Std. Dev. | 0.000141244 | 0.00025336 | 2.7904E−05 |
| Monomyristate | 1 | 2550 | 0.011388840 | 0.00913812 | 0.00070517 |
| Monomyristate | 2 | 2550 | 0.011034145 | 0.00886018 | 0.00070207 |
| | | Average | 0.011211492 | 0.00899915 | 0.00070362 |
| | | Std. Dev. | 0.000250807 | 0.00019654 | 2.1953E−06 |

Based on the results obtained from this investigation various carotenoids are soluble in sucrose monolaurate and sucrose monomyristate at low levels.

### EXAMPLE 3

The experimental procedure of Example 2 was repeated on an additional set of carotenoid samples, with the addition of a heating step. Once the 1% carotenoid samples had been prepared, they were placed in a shaking water bath at 75° C. for ten minutes.

Results were obtained after analysis by UV-Vis and HPLC. The percent soluble carotenoid values can be seen in Tables 8 and 9.

The β-carotene solubility in sucrose monolaurate was the highest on average with 0.138%. The highest soluble carotenoid in sucrose monomyristate was canthaxanthin on average with 0.059%. The percent zeaxanthin determined from lutein dry cake was not reported since the percent zeaxanthin is so much lower than lutein in dry cake and will not be at saturation.

In addition to the results in Table 8, Table 9 shows the effect heating at 75° C. has on the solubility of each carotenoid in the sucrose esters. The highest soluble carotenoid in sucrose monolaurate heated, on average was lutein with 0.0612%. The highest soluble carotenoid in sucrose monomyristate heated, on average was canthaxanthin with 0.0617%.

TABLE 8
Results of carotenoid solubilities in sucrose esters without heating

| | | | | | | |
|---|---|---|---|---|---|---|
| | | | | | Extinction | |
| Sucrose Ester | Sample | Mass (g) | Dilution | Abs @ 460 nm | Coefficient | % Carotenoids |

Canthaxanthin

| | | | | | | |
|---|---|---|---|---|---|---|
| Monolaurate | 1 | 0.10226 | 125 | 0.07372 | 2200 | 0.0410 |
| Monolaurate | 2 | 0.09946 | 125 | 0.07197 | 2200 | 0.0411 |
| | | | | | Average | 0.0410 |
| | | | | | Std. Dev. | 1.085E−4 |
| Monomyristate | 1 | 0.10631 | 125 | 0.10835 | 2200 | 0.0579 |
| Monomyristate | 2 | 0.10184 | 125 | 0.10988 | 2200 | 0.0613 |
| | | | | | Average | 0.0596 |
| | | | | | Std. Dev. | 2.40E−3 |

Zeaxanthin

| | | | | | | |
|---|---|---|---|---|---|---|
| Monolaurate | 1 | 0.10237 | 125 | 0.15987 | 2540 | 0.0768 |
| Monolaurate | 2 | 0.10596 | 125 | 0.16224 | 2540 | 0.0754 |
| | | | | | Average | 0.0761 |
| | | | | | Std. Dev. | 1.06E−3 |
| Monomyristate | 1 | 0.10980 | 5 | 0.25248 | 2540 | 0.00453 |
| Monomyristate | 2 | 0.09927 | 5 | 0.26274 | 2540 | 0.00521 |
| | | | | | Average | 0.00486 |
| | | | | | Std. Dev. | 4.83E−4 |

Astaxanthin

| | | | | | | |
|---|---|---|---|---|---|---|
| Monolaurate | 1 | 0.10706 | 2.5 | 0.30548 | 2100 | 0.00340 |
| Monolaurate | 2 | 0.10566 | 2.5 | 1.54520 | 2100 | 0.0174 |
| | | | | | Average | 0.0104 |
| | | | | | Std. Dev. | 9.91E−3 |
| Monomyristate | 1 | 0.10850 | 2.5 | 0.021387 | 2100 | 0.000235 |
| Monomyristate | 2 | 0.10880 | 2.5 | 0.027479 | 2100 | 0.000301 |
| | | | | | Average | 0.000268 |
| | | | | | Std. Dev. | 4.67E−5 |

B-Carotene

| | | | | | | |
|---|---|---|---|---|---|---|
| Monolaurate | 1 | 0.10455 | 125 | 0.31058 | 2620 | 0.142 |
| Monolaurate | 2 | 0.10538 | 125 | 0.29560 | 2620 | 0.134 |
| | | | | | Average | 0.138 |
| | | | | | Std. Dev. | 5.59E−3 |
| Monomyristate | 1 | 0.10824 | 125 | 0.013429 | 2620 | 0.00592 |
| Monomyristate | 2 | 0.10332 | 125 | 0.007252 | 2620 | 0.00335 |
| | | | | | Average | 0.00463 |
| | | | | | Std. Dev. | 1.82E−3 |

Lycopene

| | | | | | | |
|---|---|---|---|---|---|---|
| Monolaurate | 1 | 0.10090 | 2.5 | 0.17394 | 3450 | 0.00125 |
| Monolaurate | 2 | 0.10281 | 2.5 | 0.17934 | 3450 | 0.00126 |
| | | | | | Average | 0.00126 |
| | | | | | Std. Dev. | 1.05E−5 |
| Monomyristate | 1 | 0.10853 | 2.5 | 0.021128 | 3450 | 0.000141 |
| Monomyristate | 2 | 0.10080 | 2.5 | 0.026733 | 3450 | 0.000192 |
| | | | | | Average | 0.000167 |
| | | | | | Std. Dev. | 3.61E−5 |

Lutein Cake

| | | | | | HPLC Area | | % | % all |
|---|---|---|---|---|---|---|---|---|
| | Sam- | | Dilu- | Abs @ | % for all | Extinction | Caro- | trans- |
| Sucrose Ester | ple | Mass (g) | tion | 460 nm | trans-lutein | Coefficient | tenoids | Lutein |
| Monolaurate | 1 | 0.10437 | 25 | 0.13201 | 76.1904 | 2550 | 0.0124 | 0.00945 |
| Monolaurate | 2 | 0.10906 | 25 | 0.13572 | 74.5010 | 2550 | 0.0122 | 0.00909 |
| | | | | | | Average | 0.0123 | 0.00927 |
| | | | | | | Std. Dev. | 1.41E−4 | 2.53E−4 |
| Monomyristate | 1 | 0.09990 | 25 | 0.11605 | 80.2375 | 2550 | 0.0114 | 0.00914 |
| Monomyristate | 2 | 0.10615 | 25 | 0.11947 | 80.2978 | 2550 | 0.0110 | 0.00886 |
| | | | | | | Average | 0.0112 | 0.00900 |
| | | | | | | Std. Dev. | 2.5E−4 | 1.97E−4 |

TABLE 9
Results of carotenoid solubilities in sucrose esters with heating

| | | | | | | |
|---|---|---|---|---|---|---|
| | | | | | Extinction | |
| Sucrose Ester | Sample | Mass (g) | Dilution | Abs @ 460 nm | Coefficient | % Carotenoids |

Canthaxanthin

| | | | | | | |
|---|---|---|---|---|---|---|
| Monolaurate | 1 | 0.10625 | 125 | 0.083477 | 2200 | 0.0446 |
| Monolaurate | 2 | 0.10681 | 125 | 0.075648 | 2200 | 0.0402 |
| | | | | | Average | 0.0424 |
| | | | | | Std. Dev. | 3.11E−03 |
| Monomyristate | 1 | 0.10378 | 125 | 0.11267 | 2200 | 0.0617 |
| Monomyristate | 2 | 0.10532 | 125 | 0.11221 | 2200 | 0.0605 |
| | | | | | Average | 0.0611 |
| | | | | | Std. Dev. | 8.13E−04 |

Canthaxanthin Purity Correction

| | | |
|---|---|---|
| Monolaurate | 1 | |
| Monolaurate | 2 | |
| | | Average |
| | | Std. Dev. |
| Monomyristate | 1 | |
| Monomyristate | 2 | |
| | | Average |
| | | Std. Dev. |

Zeaxanthin

| | | | | | | |
|---|---|---|---|---|---|---|
| Monolaurate | 1 | 0.10835 | 25 | 0.46204 | 2540 | 0.0420 |
| Monolaurate | 2 | 0.10818 | 25 | 0.42337 | 2540 | 0.0385 |
| | | | | | Average | 0.0402 |
| | | | | | Std. Dev. | 2.44E−03 |
| Monomyristate | 1 | 0.10156 | 25 | 0.21500 | 2540 | 0.0208 |
| Monomyristate | 2 | 0.10223 | 25 | 0.21709 | 2540 | 0.0209 |
| | | | | | Average | 0.0209 |
| | | | | | Std. Dev. | 4.57E−05 |

Astaxanthin

| | | | | | | |
|---|---|---|---|---|---|---|
| Monolaurate | 1 | 0.10595 | 2.5 | 0.27123 | 2100 | 0.00305 |
| Monolaurate | 2 | 0.10849 | 2.5 | 0.27877 | 2100 | 0.00306 |
| | | | | | Average | 0.00305 |
| | | | | | Std. Dev. | 8.05E−06 |
| Monomyristate | 1 | 0.10296 | 2.5 | 0.10202 | 2100 | 0.00118 |
| Monomyristate | 2 | 0.10100 | 2.5 | 0.10147 | 2100 | 0.00120 |
| | | | | | Average | 0.00119 |
| | | | | | Std. Dev. | 1.16E−05 |

B-Carotene

| | | | | | | |
|---|---|---|---|---|---|---|
| Monolaurate | 1 | 0.10109 | 2.5 | 0.16554 | 2620 | 0.00156 |
| Monolaurate | 2 | 0.10406 | 2.5 | 0.15921 | 2620 | 0.00146 |
| | | | | | Average | 0.00151 |
| | | | | | Std. Dev. | 7.26E−05 |
| Monomyristate | 1 | 0.10257 | 2.5 | 0.13051 | 2620 | 0.00121 |
| Monomyristate | 2 | 0.10410 | 2.5 | 0.16252 | 2620 | 0.00149 |
| | | | | | Average | 0.00135 |
| | | | | | Std. Dev. | 1.95E−04 |

Lutein Cake

| | | | | | HPLC Area | | % | % all |
|---|---|---|---|---|---|---|---|---|
| | Sam- | | Dilu- | Abs @ | % for all | Extinction | Caro- | trans- |
| Sucrose Ester | ple | Mass (g) | tion | 460 nm | trans-lutein | Coefficient | tenoids | Lutein |
| Monolaurate | 1 | 0.10407 | 25 | 0.68915 | 94.8404 | 2550 | 0.0649 | 0.0616 |
| Monolaurate | 2 | 0.10205 | 25 | 0.66690 | 94.9171 | 2550 | 0.0641 | 0.0608 |
| | | | | | | Average | 0.0645 | 0.0612 |
| | | | | | | Std. Dev. | 6.03E−04 | 5.37E−04 |
| Monomyristate | 1 | 0.10453 | 25 | 0.36631 | 94.9231 | 2550 | 0.0344 | 0.0326 |
| Monomyristate | 2 | 0.10215 | 25 | 0.37561 | 95.0436 | 2550 | 0.0360 | 0.0343 |
| | | | | | | Average | 0.0352 | 0.0334 |
| | | | | | | Std. Dev. | 1.20E−03 | 1.17E−03 |

Particle size was determined using dynamic light scattering and the results are reported in Table 10. The particle sizes of samples prepared according to the present invention ranged from 4.0 nm to 5.5 nm. Another sample was prepared according to the teachings of U.S. patent application Ser. No. 09/999,863, now U.S. Pat. No. ______. This sample was also analyzed and had an average particle size of 5537.6 nm.

TABLE 10
Particle size analysis (volume weighting)

| | Mean Diameter | |
|---|---|---|
| Sample | (nm) | Percent |
| U.S. Patent application No. 09/999,863 | 5537.6 | 97.2 |
| Present Method: β-Carotene (Heated) | 5.5 | 99.5 |
| Present Method: β-Carotene (No Heat) | 4.4 | 99.4 |
| Present Method: Lutein Cake (Heated) | 4.0 | 100.0 |
| Present Method: Cake (No Heat) | 4.0 | 99.2 |

The foregoing description comprise illustrative embodiments of the present inventions. The foregoing embodiments and the methods described herein may vary based on the ability, experience, and preference of those skilled in the art. Merely listing the steps of the method in a certain order does not necessarily constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1. A process for the preparation of a stable solution of a carotenoid in an aqueous medium, comprising the steps of:
(a) dispersing between about 1 and 50 weight percent of an ester having an HLB number of between about 15 and about 18 in an aqueous medium; and
(b) adding a carotenoid-containing ingredient in an amount between about 0.1 and about 2 weight percent.

2. A process as defined in claim 1, wherein the ester is selected from the group consisting of sucrose fatty acid esters and polyglycerol esters.

3. A process as defined in claim 1, wherein the carotenoid-containing ingredient includes a carotenoid selected from the group consisting of actinioerythrol, astaxanthin, bixin, canthaxanthin, capsanthin, capsorubin, β-8′-apo-carotenal (apo-carotenal), β-12′-apo-carotenal, α-carotene, β-carotene, “carotene” (a mixture of α- and β-carotenes), γ-carotene, β-cryptoxanthin, lutein, lycopene, violerythrin, zeaxanthin, and esters of hydroxyl- or carboxyl-containing members thereof.

4. A process as defined in claim 1, further comprising the addition of an anti-foam agent selected from the group consisting of silicone based anti-foam agents including polydimethylsiloxane.

5. A process as defined in claim 1, further comprising the step of adding between about 0.1 and 1.0 weight percent an anitoxidant.

6. A process as defined in claim 5, wherein the antioxidant is selected from the group consisting of tocopherols, extracts of rosemary, ascorbyl palmitate, citric acid, ascorbic acid, BHA, and BHT.

7. A process as defined in claim 1, further comprising the step of adding an alcohol in an amount between about 0 and 4 weight percent to reduce the viscosity of the dispersion.

8. A process as defined in claim 1, further comprising the step of drying the composition to form a powder.

9. A process as defined in claim 9, wherein the step of drying is selected from the group consisting of lyophilization, spray drying, and horizontal thin-film evaporation.

10. A concentrated product containing a finely dispersed carotenoid for use in supplementing foods, beverages, and personal care products, created by the process of claim 1.

11. A food, beverage, or personal care product supplemented with a carotenoid, created by adding the concentrated product of claim 10 during processing of the food, beverage, or personal care product.

12. A carotenoid-containing liquid, comprising a food-grade aqueous solvent in which is dispersed particles of the carotenoid that will pass through a 0.2 micron filter.
